(19) United States
(12) Patent Application Publication
(10) Pub. No.: US 2023/0047872 A1
(43) Pub. Date: Feb. 16, 2023

(54) MULTIMODAL OCCUPANT-SEAT MAPPING FOR SAFETY AND PERSONALIZATION APPLICATIONS

(71) Applicant: GM GLOBAL TECHNOLOGY OPERATIONS LLC, Detroit, MI (US)

(72) Inventors: Alaa Mohamed Khamis, Courtice (CA); Wei Tong, Troy, MI (US); Arief Barkah Koesdwiady, Oshawa (CA); Roddi Lynn MacInnes, Bowmanville (CA); Neeraj R. Gautama, Whitby (CA)

(73) Assignee: GM GLOBAL TECHNOLOGY OPERATIONS LLC, Detroit, MI (US)

(21) Appl. No.: 17/444,824

(22) Filed: Aug. 10, 2021

(51) Int. Cl. B60K 35/00; B60N 2/00; G01D 21/02

(52) U.S. Cl. CPC B60K 35/00; B60N 2/002; G01D 21/02; G06K 9/6289

(57) ABSTRACT

In accordance with an exemplary embodiment, a system is provided that includes one or more first sensors, one or more second sensors, and a processor. The one or more first sensors are of a first sensor modality configured to obtain first sensor data pertaining to an occupancy status of one or more seats of a vehicle. The one or more second sensors are of a second sensor modality, different from the first sensor modality, configured to obtain second sensor data pertaining to the occupancy status of the one or more seats of the vehicle. The processor is coupled to the one or more first sensors and the one or more second sensors, and is configured to at least facilitate determining the occupancy status of the one or more seats of the vehicle based on a fusion of the first sensor data and the second sensor data.

### TECHNICAL FIELD

The technical field generally relates to vehicles and, more specifically, to methods and systems for occupant-seat mapping of the vehicles.

Certain vehicles today include systems for determining whether a seat of the vehicle includes an occupant or object. However, existing systems may not always provide optimal assessment of the occupant or object on the seat.

Accordingly, it is desirable to provide improved methods and systems for assessing a status of seats of the vehicle, including of occupants or objects on the seats.

### SUMMARY

In accordance with an exemplary embodiment, a system is provided that includes one or more first sensors, one or more second sensors, and a processor. The one or more first sensors are of a first sensor modality configured to obtain first sensor data pertaining to an occupancy status of one or more seats of a vehicle. The one or more second sensors are of a second sensor modality, different from the first sensor modality, configured to obtain second sensor data pertaining to the occupancy status of the one or more seats of the vehicle. The processor is coupled to the one or more first sensors and the one or more second sensors, and is configured to at least facilitate determining the occupancy status of the one or more seats of the vehicle based on a fusion of the first sensor data and the second sensor data.

Also in an exemplary embodiment, the one or more seats includes a plurality of seats of the vehicle, and the processor is configured to: generate an occupant seat map for the vehicle based on the occupancy status of each of the plurality of seats; and provide instructions for controlling one or more vehicle systems based on the occupant seat map.

Also in an exemplary embodiment, the processor is configured to generate the occupant seat map based on different preliminary maps for the first sensor modality and the second sensor modality with different weights assigned to each of the different preliminary maps.

Also in an exemplary embodiment, the processor is configured to: provide instructions for a display system to display the occupant seat map for a user of the vehicle; and refine the occupant seat map based on inputs provided by the user of the vehicle.

Also in an exemplary embodiment, the first and second modalities include two or more of the following: a weight sensing modality, a vision sensing modality, a range sensing modality, an audio sensing modality, and a biometric sensing modality.

Also in an exemplary embodiment, the first sensor modality includes a weight sensing modality; and the second sensor modality includes a vision sensing modality.

Also in an exemplary embodiment, the system further includes one or more third sensors of a third sensor modality, different from both the first sensor modality and the second sensor modality, and configured to obtain third sensor data pertaining to the occupancy status of the one or more seats of the vehicle; and the processor is configured to at least facilitate determining the occupancy status of the one or more seats of the vehicle based on fusion of the first sensor data, the second sensor data, and the third sensor data.

Also in an exemplary embodiment, the first, second, and third modalities include three or more of the following: a weight sensing modality, a vision sensing modality, a range sensing modality, an audio sensing modality, and a biometric sensing modality.

Also in an exemplary embodiment, the first sensor modality includes a weight sensing modality; the second sensor modality includes a vision sensing modality; and the third sensor modality includes an audio sensing modality.

In another exemplary embodiment, a method is provided that includes: obtaining, via one or more first sensors of a first sensor modality, first sensor data pertaining to an occupancy status of one or more seats of a vehicle; obtaining, via one or more second sensors of a second sensor modality, different from the first sensor modality, second sensor data pertaining to the occupancy status of the one or more seats of the vehicle; and determining, via a processor, the occupancy status of the one or more seats of the vehicle based on a fusion of the first sensor data and the second sensor data.

Also in an exemplary embodiment, the one or more seats includes a plurality of seats of the vehicle, and the method further includes: generating, via the processor, an occupant seat map for the vehicle based on the occupancy status of each of the plurality of seats; and providing, via the processor, instructions for controlling one or more vehicle systems based on the occupant seat map.

Also in an exemplary embodiment, the step of generated the occupant seat map includes generating the occupant seat map based on different preliminary maps for the first sensor modality and one or more second sensor modalities with different weights assigned to each of the different preliminary maps.

Also in an exemplary embodiment, the method further includes: displaying the occupant seat map for a user of the vehicle, via a display system in accordance with instructions provided by the processor; and refining, via the processor, the occupant seat map based on inputs provided by the user of the vehicle.

Also in an exemplary embodiment, the first and second modalities include two or more of the following: a weight sensing modality, a vision sensing modality, a range sensing modality, an audio sensing modality, and a biometric sensing modality.

Also in an exemplary embodiment, the first sensor modality includes a weight sensing modality; and the second sensor modality includes a vision sensing modality.

Also in an exemplary embodiment, the method further includes: obtaining, via one or more third sensors of a third sensor modality, different from both the first sensor modality and the second sensor modality, third sensor data pertaining to the occupancy status of the one or more seats of the vehicle; wherein the step of determining the occupancy status includes determining, via the processor, the occupancy status of the one or more seats of the vehicle based on fusion of the first sensor data, the second sensor data, and the third sensor data.

Also in an exemplary embodiment, the first, second, and third modalities include three or more of the following: a weight sensing modality, a vision sensing modality, a range sensing modality, an audio sensing modality, and a biometric sensing modality.

Also in an exemplary embodiment, the first sensor modality includes a weight sensing modality; the second sensor modality includes a vision sensing modality; and the third sensor modality includes an audio sensing modality.

In another exemplary embodiment, a vehicle is provided that includes: a body; a propulsion system configured to generate movement of the body; one or more first sensors of a first sensor modality configured to obtain first sensor data pertaining to an occupancy status of one or more seats of a vehicle; one or more second sensors of a second sensor modality, different from the first sensor modality, configured to obtain second sensor data pertaining to the occupancy status of the one or more seats of the vehicle; and a processor coupled to the one or more first sensors and the one or more second sensors and configured to at least facilitate determining the occupancy status of the one or more seats of the vehicle based on a fusion of the first sensor data and the second sensor data.

Also in an exemplary embodiment, the one or more seats includes a plurality of seats of the vehicle, and the processor is configured to: generate an occupant seat map for the vehicle based on the occupancy status of each of the plurality of seats; and provide instructions for controlling one or more vehicle systems based on the occupant seat map.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a control system for generating an occupant seat mapping of the vehicle, and that controls vehicle systems based on the occupant seat mapping, in accordance with exemplary embodiments;

FIG. 2 is a flowchart of a process for generating an occupant seat mapping of a vehicle and for controlling vehicle systems based on the occupant seat mapping, and that can be implemented in connection with the vehicle of FIG. 1, in accordance with exemplary embodiments;

FIG. 3 is an illustration of an occupant seat mapping of a vehicle, and that can be generated by and implemented in connection with the vehicle of FIG. 1 and the process of FIG. 2, in accordance with exemplary embodiments;

FIG. 4 is a flowchart of a sub-process of the process of FIG. 2, including the generation of a vision-based occupant-seat map, and that can be implemented in connection with the vehicle of FIG. 1, in accordance with exemplary embodiments;

FIG. 5 is a flowchart of an additional sub-process of the process of FIG. 2, including the generation of a speech-based occupant-seat map, and that can be implemented in connection with the vehicle of FIG. 1, in accordance with exemplary embodiments; and

FIG. 6 is a flowchart of an additional sub-process of the process of FIG. 2, including an occupant interaction in confirming or refining the occupant-seat map, and that can be implemented in connection with the vehicle of FIG. 1, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

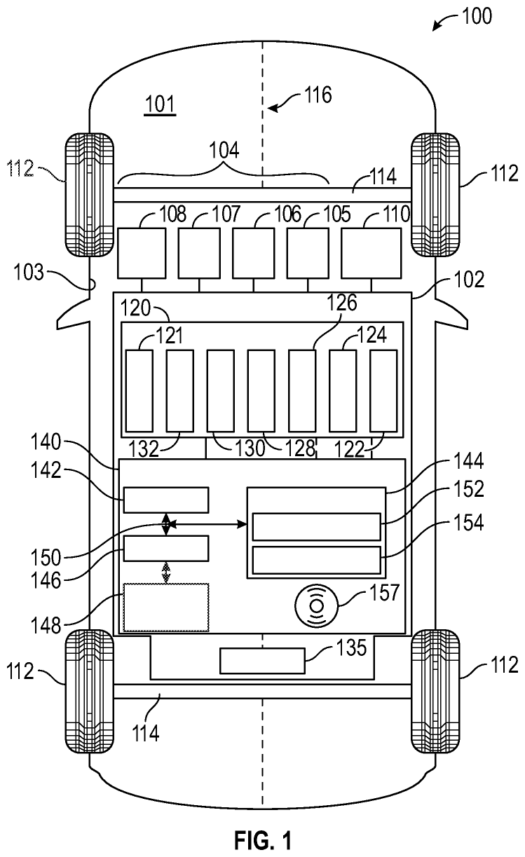

FIG. 1 illustrates a vehicle 100 according to an exemplary embodiment. As described in greater detail further below, the vehicle 100 includes a control system 102 for generating an occupant seat mapping of a vehicle and for controlling vehicle systems based on the occupant seat mapping.

In various embodiments, the vehicle 100 comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, such as aircraft, spacecraft, watercraft, and so on, and/or one or more other types of mobile platforms (e.g., a robot and/or other mobile platform).

The vehicle 100 includes a body 103 that is arranged on a chassis 116. The body 103 substantially encloses other components of the vehicle 100. The body 103 and the chassis 116 may jointly form a frame. The vehicle 100 also includes a plurality of wheels 112. The wheels 112 are each rotationally coupled to the chassis 116 near a respective corner of the body 103 to facilitate movement of the vehicle 100. In one embodiment, the vehicle 100 includes four wheels 112, although this may vary in other embodiments (for example for trucks and certain other vehicles).

A drive system 110 is mounted on the chassis 116, and drives the wheels 112, for example via axles 114. The drive system 110 preferably comprises a propulsion system. In certain exemplary embodiments, the drive system 110 comprises an internal combustion engine and/or an electric motor/generator, coupled with a transmission thereof. In certain embodiments, the drive system 110 may vary, and/or two or more drive systems 110 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

As depicted in FIG. 1, the vehicle also includes various controlled systems 104 that are controlled by the control system 102 at least in part based on the occupant seat mapping that is generated by the control system 102. As depicted in FIG. 1, in various embodiments, the various controlled systems 104 include an airbag system 105, a seat belt system 106, and an infotainment system 107 for the vehicle 100, and that are controlled by the control system 102 at least in part based on the occupant seat mapping that is generated by the control system 102. For example, in various embodiments, deployment of airbags of the airbag system 105 are controlled based at least in part on a size and/or age of occupants in the vehicle seats. Also in various embodiments, adjustments of the seat belt system 106 are also implemented controlled based at least in part on a size and/or age of occupants in the vehicle seats. In addition, in various embodiments, customization of content provided via the vehicle infotainment system 107 (e.g., for educational and/or entertainment content) may be customized based on the age of the occupants in the vehicle 100. Also in certain embodiments, as depicted in FIG. 1, one or more other systems 108 may also be controlled based at least in part on the size and/or age of the vehicle occupants, such as by way of example, door locks, door windows, and/or other vehicle systems.

In the embodiment depicted in FIG. 1, the control system 102 is coupled to the various controlled systems 104 (e.g., including the airbag system 105, the seat belt system 106, the infotainment system 107, and/or one or more other systems 108), and to the drive system 110. Also as depicted in FIG. 1, in various embodiments, the control system 102 includes a sensor array 120, a display system 135, a controller 140.

In various embodiments, the sensor array 120 includes various sensors that obtain sensor data for use in generating and/or implementing an occupant seat mapping for the vehicle 100. In the depicted embodiment, the sensor array 120 includes one or more occupant sensors 121, weight sensors 122, cameras 124, range sensors 126, audio sensors 128, biometric sensors 130, and input sensors 132.

In various embodiments, the occupant sensors 121 include one or more mass sensors, force detection sensors, and/or other sensors coupled to one or more seats of the vehicle 100 and configured to detect the presence of an occupant or object on the vehicle seats. Also in various embodiments, the weight sensors 122 are configured to measure a weight (and/or mass) of an occupant and/or object on the vehicle seat. In certain embodiments, the cameras 124 are disposed inside a cabin of the vehicle 100, and face inside the cabin.

Also in various embodiments, the cameras 124 obtain camera sensor data of occupants and/or objects inside the cabin of the vehicle 100, including on the vehicle seats. In certain embodiments, the cameras 124 comprise one or more visible light cameras inside an interior (e.g., cabin) of the vehicle 100. Also in certain embodiments, the cameras 124 may comprise one or more infrared cameras, and/or other cameras inside the interior (e.g., cabin) of the vehicle 100.

In certain embodiments, the range sensors 126 include one or more radar sensors (e.g., low energy radar sensors), and/or in certain embodiments one or more Lidar, sonar, and/or other range sensors. In certain embodiments, the audio sensors 128 include one or more microphones and/or other audio sensors disposed inside the cabin and/or configured to capture audio signals (including speech utterances and signals) inside the cabin of the vehicle 100.

Also in certain embodiments, the biometric sensors 130 include one or more sensors configured to detect and/or measure one or more biometric parameters of an occupant inside the vehicle 100 (including on the vehicle seats), such as heartbeat, breathing, brainwaves, and/or other biometric parameters for the occupant. In addition, in certain embodiments, the input sensors 132 comprise one or more touch screen sensors, additional audio sensors (microphones), and/or other input sensors configured to obtain inputs from a driver and/or other occupant of the vehicle 100 (including as to confirmation and/or refinement of an occupant seat map for the vehicle generated by the controller 140).

In various embodiments, the display system 135 provides notifications to a driver or other user of the vehicle 100 as to a preliminary occupant seat map of the vehicle 100 as generated via the controller 140. Also in various embodiments, the display system 135 allows the driver or other user of the vehicle 100 the opportunity to confirm and/or refine the preliminary occupant seat map, for example via interaction with the display system 135 as detected via the input sensors 132. In certain embodiments, the display system 135 provides a visual depiction of the occupant seat map, for example via a display screen. In certain embodiments, an audio, haptic and/or other description of the occupant seat map and/or information pertaining thereto may be provided by the display system 135.

In various embodiments, the controller 140 is coupled to the sensor array 120 and the display system 135. In addition, in various embodiments, the controller 140 is also coupled to the drive system 110 and/or one or more of the controlled systems 104 (e.g., including the airbag system 105, the seat belt system 106, the infotainment system 107, and/or one or more other systems 108).

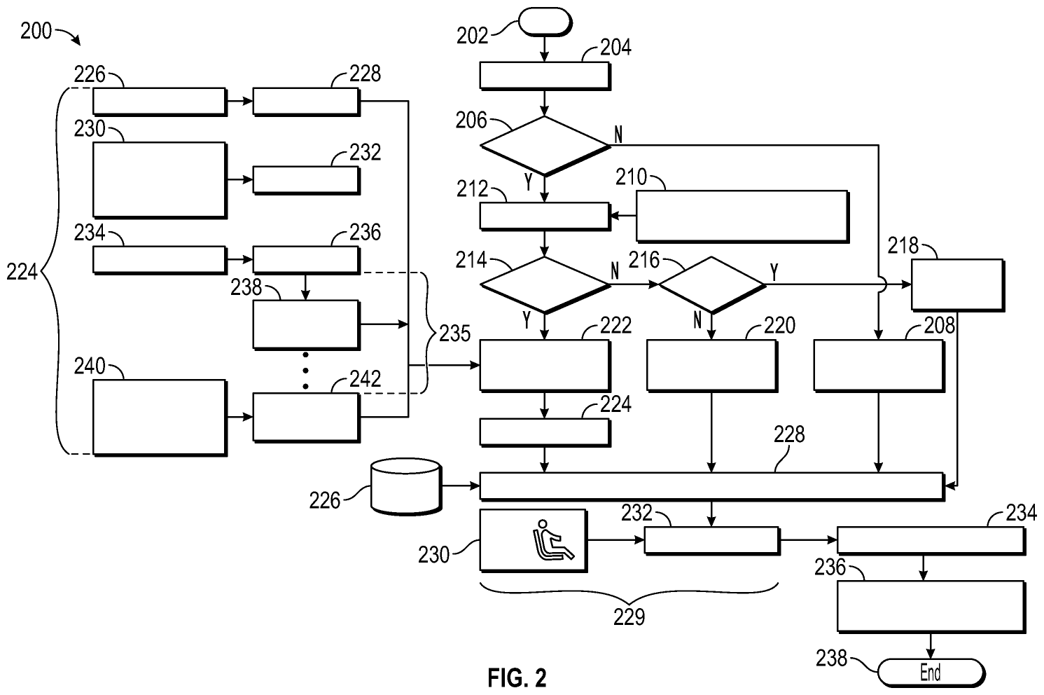

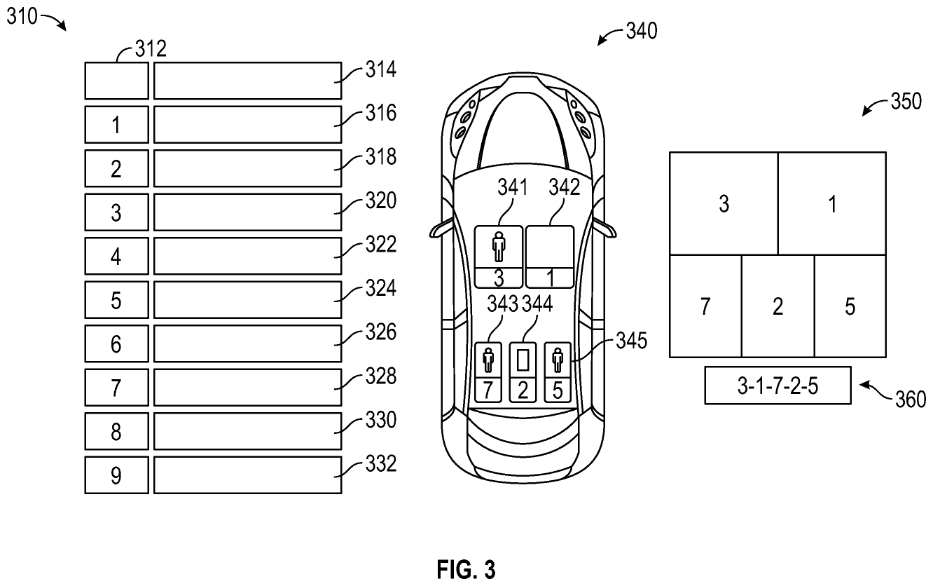

In various embodiments, the controller 140 comprises a computer system (also referred to herein as computer system 14), and includes a processor 142, a memory 144, an interface 146, a storage device 148, and a computer bus 150. In various embodiments, the controller (or computer system) 140 generates an occupant seat map for the vehicle 100 and controls vehicle operation, including operation of the controlled systems 104 based on the occupant seat map. In various embodiments, the controller 140 provides these and other functions in accordance with the steps of the process of FIG. 2 and the implementations and sub-processes of FIGS. 3-6.

In various embodiments, the controller 140 (and, in certain embodiments, the control system 102 itself) is disposed within the body 103 of the vehicle 100. In one embodiment, the control system 102 is mounted on the chassis 116. In certain embodiments, the controller 140 and/or control system 102 and/or one or more components thereof may be disposed outside the body 103, for example on a remote server, in the cloud, or other device where image processing is performed remotely.

It will be appreciated that the controller 140 may otherwise differ from the embodiment depicted in FIG. 1. For example, the controller 140 may be coupled to or may otherwise utilize one or more remote computer systems and/or other control systems, for example as part of one or more of the above-identified vehicle 100 devices and systems.

In the depicted embodiment, the computer system of the controller 140 includes a processor 142, a memory 144, an interface 146, a storage device 148, and a bus 150. The processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 140 and the computer system of the controller 140, generally in executing the processes described herein, such as the process 200 discussed further below in connection with FIG. 2 and the implementations and sub-processes of FIGS. 3-6.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted embodiment, the memory 144 stores the above-referenced program 152 along with various stored values 154 (e.g., including, in various embodiments, stored measurements of height, weight, skeletal features, biometric data, and/or other characteristics identifying different categorizations of objects and/or occupants in the seats of the vehicle 100).

The bus 150 serves to transmit programs, data, status and other information or signals between the various components of the computer system of the controller 140. The interface 146 allows communication to the computer system of the controller 140, for example from a system driver and/or another computer system, and can be implemented using any suitable method and apparatus. In one embodiment, the interface 146 obtains the various data from the sensor array 120. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of one or more processes of the present disclosure, such as the steps of the process 200 discussed further below in connection with FIG. 2 and the implementations and sub-processes of FIGS. 3-6. In another exemplary embodiment, the program product may be directly stored in and/or otherwise accessed by the memory 144 and/or a disk (e.g., disk 157), such as that referenced below.

The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 140 may also otherwise differ from the embodiment depicted in FIG. 1, for example in that the computer system of the controller 140 may be coupled to or may otherwise utilize one or more remote computer systems and/or other control systems.

FIG. 2 is a flowchart of a process 200 for generating an occupant seat mapping of a vehicle and for controlling vehicle systems based on the occupant seat mapping, in accordance with exemplary The process 200 can be implemented in connection with the vehicle 100 of FIG. 1, in accordance with exemplary embodiments. The process 200 of FIG. 2 will also be discussed further below in connection and FIGS. 3-6, which show different implementations and sub-processes of the process 200 in accordance with various embodiments.

As depicted in FIG. 2, the process begins at step 202. In one embodiment, the process 200 begins when a vehicle drive or ignition cycle begins, for example when a driver approaches or enters the vehicle 100, or when the driver turns on the vehicle and/or an ignition therefor (e.g. by turning a key, engaging a keyfob or start button, and so on). In one embodiment, the steps of the process 200 are performed continuously during operation of the vehicle.

In various embodiments, during step 204, occupant sensor data is obtained. In various embodiments, sensor data is obtained from one or more of the occupant sensors 121 of FIG. 1 regarding the presence of objects and/or occupants in the seats of the vehicle 100 (e.g., of one or more vehicle seats 101 of FIG. 1). Similar to the discussion above with respect to the occupant sensors 121 of FIG.1, in various embodiments, the occupant sensor data may be obtained via a first sensor modality, by one or more weight sensors, mass sensors, force sensors, and/or other occupant sensors.

In various embodiments, during step 206, a determination is made as to whether a vehicle seat is occupied. In various embodiments, the processor 142 of FIG. 1 determines whether each vehicle seat 101 is occupied based on occupant sensor data obtained from each of the vehicle seats 101.

In various embodiments, for each vehicle seat, if it is determined that the vehicle seat is unoccupied, then the process proceeds to step 208. During step 208, the seat state is set equal to “unoccupied” by the processor. In various embodiments, the process then proceeds to step 228 (described further below).

Conversely, if it is instead determined that the vehicle seat is occupied, then additional sensor data is obtained (step 210). In various embodiments, the additional sensor data is obtained via sensor data from one or more second sensor modalities that are different from the first sensor modality of step 204. In certain embodiments, the additional sensor data of step 210 is from camera data (e.g., from one or cameras 124 of FIG. 1, such as from one or more visible light cameras generating vision data, and/or from one or more infrared, and/or other cameras) and/or from range sensor data (e.g., from one or more range sensors 126 of FIG. 1, such as from one or more low energy radar, other radar, Lidar, sonar, and/or other range sensors).

In various embodiments, an identification is made of the occupant or object of each vehicle seat (step 212). In various embodiments, for each vehicle seat, the processor 142 makes an identification of the occupant or object based on the additional sensor data of step 210 (e.g., via the camera vision data, other camera data, and/or range data from the cameras 124 and/or range sensors 126 of FIG. 1).

In various embodiments, for each vehicle seat, a determination is made as to whether the occupant or object is human (step 214). In various embodiments, for each vehicle seat, the processor 142 determines whether or not the occupant or object is human based on the identification of step 212 (e.g., based on a comparison of the additional sensor data with one or more stored values 154 in the memory 144 of FIG. 1).

In various embodiments, if it is determined at step 214 that the occupant or object is not human, then a determination is made as to whether the occupant or object is a pet (i.e., an animal) (step 216). In various embodiments, for each vehicle seat, the processor 142 determines whether or not the occupant or object is a pet (i.e., an animal) based on the identification of step 212 (e.g., based on a comparison of the additional sensor data with one or more stored values 154 in the memory 144 of FIG. 1).

In various embodiments, if it is determined at step 216 that the occupant or object is a pet, then the process proceeds to step 218. During step 218, the seat state is set equal to “pet” by the processor. In various embodiments, the process then proceeds to step 228 (described further below).

Conversely, in various embodiments, if it is instead determined that the occupant or object is not a pet, then the process proceeds instead to step 220. During step 220, the seat state is set equal to “object” by the processor. In various embodiments, the process then proceeds to step 228 (described further below).

With reference back to step 214, in various embodiments, if it is determined that the occupant or object is human, then various further sensor data is obtained and analyzed (referenced in FIG. 2 as combined steps 224). As depicted in FIG. 2, in various embodiments, further sensor data is obtained via sensor data from one or more additional sensor modalities that are different from the first sensor modality of step 204, for example as described below in connection with steps 226-242 (which are also collectively referred to as combined step 224 with reference to FIG. 2).

In certain embodiments, occupant weight sensor data is obtained (step 226). In various embodiments, occupant weight sensor is obtained via one or more weight sensors 122 of FIG. 1 for each vehicle seat. Also in various embodiments, a weight is determined for each such occupant (step 228). In various embodiments, the weight is determined by the processor 142 of FIG. 1 based on the weight sensor data and/or is measured directly by the one or more weight sensors 122.

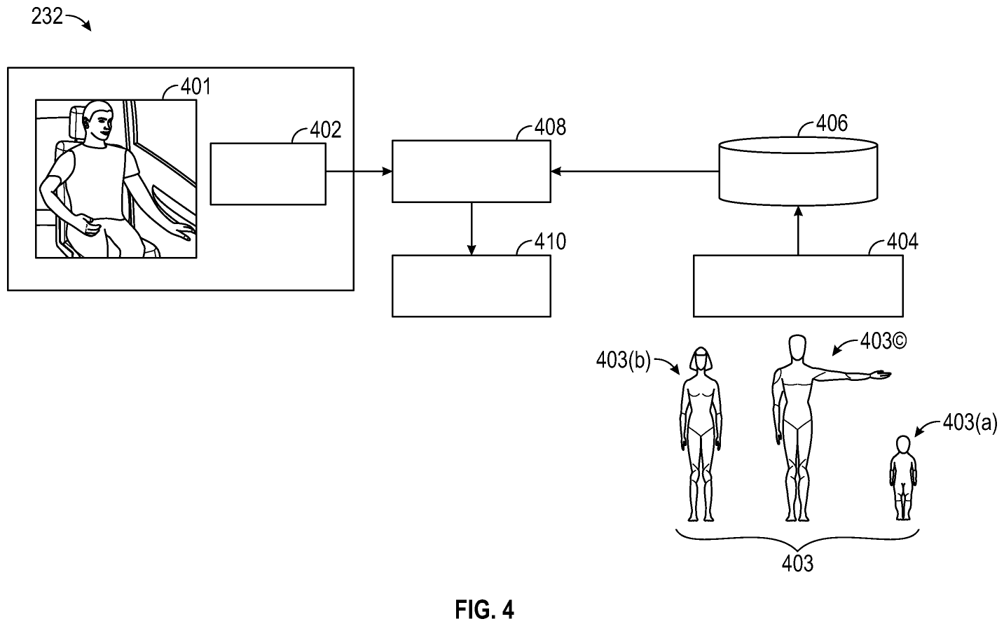

Also in certain embodiments, camera and/or range data are obtained (step 230). In various embodiments, camera and/or range sensor data are obtained via one or more cameras 124 (e.g., visible light and/or infrared cameras) and/or range sensors 126 (e.g., low energy radar and/or other range sensors) for each vehicle seat. Also in various embodiments, a pose estimation is determined for each such occupant (step 232). In various embodiments, the pose estimation is determined by the processor 142 of FIG. 1 based on the camera and/or range sensor data (e.g., from vision data from a visible light camera, and/or in certain embodiments from other camera data and/or range data), and is described further below in connection with FIG. 4 in accordance with an exemplary embodiment.

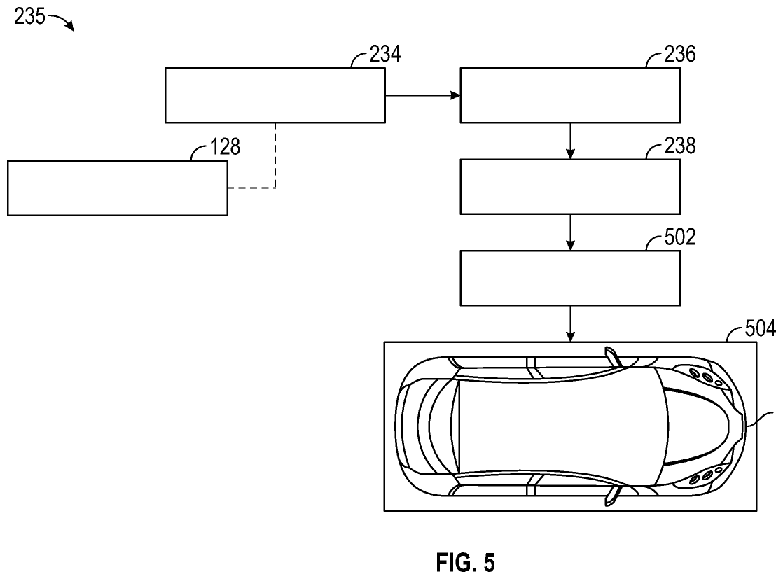

Also in certain embodiments, audio sensor data is obtained (step 234). In various embodiments, audio sensor data (e.g., speech data of occupants of the vehicle seats) is obtained via one or more audio sensors 128 (e.g., microphones inside the vehicle) for each vehicle seat. Also in various embodiments, source estimation (step 236) and acoustic feature extraction (step 238) are performed for the audio sensor data. In various embodiments, the processor 142 performs the source estimation of step 236 and the acoustic feature extraction of step 238 using the audio sensor data of step 234, in analyzing the audio data. As shown in FIG. 2, this analyzing of the audio data (of steps 236 and 238) may also be collectively referred to as a combined step 235 of audio sensor data analysis, which is described further below in connection with FIG. 5 in accordance with an exemplary embodiment.

Also in certain embodiments, biometric audio sensor data is obtained (step 240). In various embodiments, biometric sensor data (e.g., heart rate data, brain wave data, breathing data, and so on) is obtained via one or more biometric sensors 130 for each vehicle seat. Also in various embodiments, biometric values (e.g., heart rate, brain wave patterns, breathing patterns, and the like) are determined at step 242 with respect to the biometric sensor data. In various embodiments, the processor 142 performs the determinations of the biometric values based on the biometric sensor data.

In various embodiments, mapping is performed for the human occupant (step 222). In various embodiments, the processor 142 performs a mapping of characteristics of the human occupant (including as to size and age) based on different types of sensor data reflecting multiple different sensor modalities, including various of the sensor modalities represented in steps 224-242 and described above. In certain embodiments, this results in multiple mappings of the human occupant based on the different sensor modality (e.g., in certain embodiments, one or more first mappings based on weight sensor data, one or more additional mappings based on camera data and/or range sensor data, one or more additional mappings based on audio sensor data, one or more additional mappings based on biometric data, and so on. In certain embodiments, during step 222, each of these different mappings is generated by the processor 142 using Bayesian mathematical techniques.

In addition, in various embodiments, map integration is performed (step 224). In various embodiments, during step 224, the processor 142 integrates the various mappings of the different modalities from step 222, in generating a comprehensive and/or combined mapping of the human occupant, including as to size (e.g., weight and height) and age.

In various embodiments, during step 228 the combined mapping of step 224 (for seats occupied by a human) is further combined with the seat settings of steps 208 (for unoccupied seats), 218 (for seats occupied by a pet) and 220 (for seats occupied by an object other than a human or a pet), in order to generate a preliminary consolidated seat mapping for the vehicle (including for all of the seats thereof). In various embodiments, the preliminary consolidated seat mapping of step 228 is generated by the processor 142 using the mappings/states of steps 208, 218, 220, and 220 for the various vehicle seats while also using any a priori information (which may be obtained separately at step 226 as denoted in FIG. 2). For example, in certain embodiments, such a priori information may include that an adult (rather than a child) would typically be in the driver seat while the vehicle is being operated, and so on. In various embodiments, the preliminary occupant seat map includes a depiction of each vehicle seat along with a classification of any occupant or object on the vehicle seat (e.g., whether the vehicle seat is unoccupied, occupied by an occupied by an object, occupied by a pet, occupied by a small, mid-size, or large child, or occupied by a small, mid-size, or large adult). An example of such an occupant seat map is depicted in FIG. 3 and is described further below in connection therewith.

In certain embodiments, during step 228, the different occupant seat mappings from the different sensor modalities are each weighted in determining the preliminary consolidated seat mapping. In certain embodiments, the different occupant seat mappings from the different sensor modalities are each weighted the same in determining the preliminary consolidated seat mapping. In certain other embodiments, the different occupant seat mappings from the different sensor modalities are each weighted differently, based on different respective confidences and/or expected accuracies, in determining the preliminary consolidated seat mapping. For example, in certain embodiments, probabilistic information fusion is used to produce the preliminary consolidated occupant seat map.

For example, in certain embodiments, during step 228, the information fusion is conducted by first making the following assumptions: (i) p_{w} probability of detecting an adult by weight-based estimator with variance σ_{w}; (ii) pᵥ probability of detecting an adult by vision-based estimator with variance σ^{v}; (iii) pₛ represents the probability of detecting an adult by speech-based estimator with variance σₛ; and (iv) w_{w}, wᵥ and wₛ are weights to aggregate the multiple predictions.

Also in certain embodiments, these weights are inversely proportional to the variance of each sensing modality. The probability of the seat occupancy is then in accordance with the following equation:

$$p [ s ( seat ) ] = sig ( \frac{{w}_{w}}{{w}_{w} + {w}_{v} + {w}_{s}} {p}_{w} + \frac{{w}_{v}}{{w}_{w} + {w}_{v} + {w}_{s}} {p}_{v} + \frac{{w}_{s}}{{w}_{w} + {w}_{v} + {w}_{s}} {p}_{s} ) . \qquad ( Equation 1 )$$

Also in various embodiments, with reference to Equation 1: (i) If 0.5<p[s(seat)]≤1, then the vehicle seat is determined to be occupied by an adult. Conversely, with further reference to Equation 1: (ii) If 0≤p[s(seat)]<0.5, then the vehicle seat is determined to be occupied by a child. If p[s(seat)]=0.5, seat occupancy state is determined to be undefined.

In another exemplary embodiment, a maximum an MAP (maximum a posteriori rule) may be used, and/or with a Dempster's rule of combination, in order to provide weights for the different components of the occupant seat map. For example, in certain embodiments, different visual-based Z^{v} and speech-based estimators Z^{a} may be repeated for the various vehicle seats to generate both a vision-based mapping and a speech-based mapping (and/or to similarly generate other mappings based on other different sensor modalities).

By way of example, in certain embodiments, visual-based estimates Z^{v} for the various vehicle seats (e.g., from visible light cameras in the vehicle) may be utilized in generating a vision-based unimodal map in accordance with the following equation:

$$p [ s ( D ) = a d u l t \vert {Z}_{t}^{v} ] = \frac{p [ {Z}_{t}^{v} \vert s ( D ) = a d ult ] \cdot p [ s ( D ) = adult \vert {Z}_{t - 1}^{v} ]}{{\sum }_{s ( D )} p [ {Z}_{t}^{v} \vert s ( D ) ] \cdot p [ s ( D ) \vert {Z}_{t - 1}^{v} ]} . \qquad ( Equation 2 )$$

Where p[s(D)=adult|Zₜ^{v}] represents the probability of the driver seat to be occupied by an adult given visual observations.

By way of continued example, in certain embodiments, acoustic-based estimates Z^{a} for the various vehicle seats (e.g., from microphones in the vehicle) may be utilized in generating a speech-based unimodal map in accordance with the following equation:

$$p [ s ( D ) = a d u l t \vert {Z}_{t}^{a} ] = \frac{p [ {Z}_{t}^{a} \vert s ( D ) = adult ] \cdot p [ s ( D ) = adult \vert {Z}_{t - 1}^{a} ]}{{\sum }_{s ( D )} p [ {Z}_{t}^{a} \vert s ( D ) ] \cdot p [ s ( D ) \vert {Z}_{t - 1}^{a} ]} . \qquad ( Equation 3 )$$

Where p[s(D)=adult|Zₜ^{va}] represents the probability of the driver seat to be occupied by an adult given acoustic observations.

Also in certain embodiments, the final state of each seat is obtained by integrating recursively the individual observation (unimodal maps) into the global map by applying MAP (maximum a posteriori rule).

For example, in certain embodiments, the occupant is determined to be an adult if the integrated probability of the human occupant being an adult is greater than the integrated probability of the human occupant being a child, in accordance with the following equation:

p[s(D)=adult]>p[s(D)=child] (Equation 4).

By way of further example, in certain embodiments, the occupant is determined to be a child if the integrated probability of the human occupant being a child is greater than the integrated probability of the human occupant being an adult, in accordance with the following equation:

p[s(D)=adult]<p[s(D)=child] (Equation 5).

By way of further example, in certain embodiments, the occupant is determined to be undefined if the integrated probability of the human occupant being a child is equal to the integrated probability of the human occupant being an adult, in accordance with the following equation:

p[s(D)=adult]=p[s(D)=child] (Equation 6).

It will be appreciated that similar and/or related techniques may also be utilized with respect to other different sensor modalities and/or characteristics of the occupants of the vehicle seats and the integration of the different occupant seat maps corresponding thereto.

With continued reference to FIG. 2, also in various embodiments, as part of step 228, the preliminary occupant seat map is displayed for the vehicle. In various embodiments, the preliminary occupant seat map of step 228 is displayed for a driver or occupant of the vehicle via the display system 135 of FIG. 1 (e.g., via a display screen thereof) in accordance with instructions provided by the processor 142 of FIG. 1. In certain embodiments, one or more other types of notifications (e.g., audio and/or haptic) with information pertaining to the preliminary occupant seat map.

In various embodiments, inputs are received from a driver or other user of the vehicle (step 230). In various embodiments, user inputs are received via input sensors 132 of FIG. 1 (e.g., from a touch screen of the display system 135 and/or one or more other input devices). In various embodiments, the user inputs provide the user's confirmation and/or refinement of the preliminary occupant seat map of step 228. For example, a driver or other user may confirm that the preliminary occupant seat map is accurate, or may make an adjustment if a portion of the preliminary occupant seat map is inaccurate.

In various embodiments, the confirmation and/or refinement by the user is implemented (step 232). In various embodiments, the processor 142 enters either a confirmation or adjustment of the preliminary occupant seat map in accordance with the user inputs.

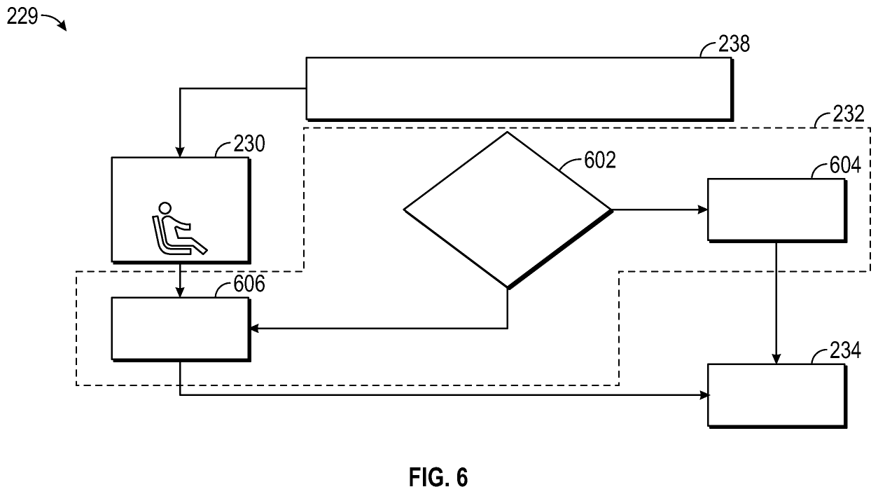

As depicted in FIG. 2, in certain embodiments steps 230 and 232 may also be considered to be a combined step 229 (of implementing user inputs from human interaction), which is described in greater detail further below in connection with FIG. 6 in accordance with an exemplary embodiment.

With continued reference to FIG. 2, in various embodiments a final occupant seat map is generated (step 234). In various embodiments, the processor 142 generates the final occupant seat map based on the preliminary occupant seat map of step 228, and after incorporating any user confirmation and/or adjustments in steps 230, 232.

Also in various embodiments, one or more vehicle actions are taken (step 236). In various embodiments, the processor 142 provides instructions for control and adjustments of operation of one or more of the controlled systems 104 of FIG. 1 based on the occupant seat map of step 234. For example, in various embodiments, air bag deployment is adjusted based on the occupant seat map, including whether any pets and/or humans are disposed in specific vehicle seats, and/or including a size of human occupants, and the like. By way of additional example, in various embodiments, seat belts are adjusted (e.g., tension, positioning, or other adjustments) based on the size of human occupants. By way of additional example, in various embodiments, infotainment (e.g., information and/or entertainment) content may be tailored based on the age of the occupants (e.g., an adult versus child friendly song, performance, and/or movie, or the like). By way of further example, one or more other vehicle systems may also be controlled and/or adjusted based on the occupant seat map (e.g., control of child locks, automatic windows, or the like).

In various embodiments, the process then terminates at step 238.

With reference to FIG. 3, an illustration is provided for implementation of an occupant seat map that may be utilized in connection with the process 200 of FIG. 2. As shown in FIG. 3, a chart 310 is illustrated with identification numbers 312 and different possible classes 314 of seat occupancy for the occupant seat map. As shown in FIG. 3, the different classes 314 may include (among other possible classes): (i) a first class 316 representing a “not occupied” seat; (ii) a second class 318 representing an “object” (e.g., nonliving); (iii) a third class 320 representing a “large adult” (e.g., in terms of height and/or weight for an adult); (iv) a fourth class 322 representing a “mid-size adult” (e.g., with height and/or weight of an adult that is less than that of a “large adult”); (v) a fifth class 324 representing a “small adult” (e.g., with height and/or weight of an adult that is less than that of a “mid-size adult”); (vi) a sixth class 326 representing a “large child” (e.g., in terms of height and/or weight for a child); (vii) a seventh class 328 representing a “mid-size adult” (e.g., with height and/or weight of a child that is less than that of a “large child”); (viii) an eighth class 330 representing a “small child” (e.g., with height and/or weight of a child that is less than that of a “mid-size child”); and (ix) a ninth class for a pet (e.g., animal).

Also depicted in FIG. 3 are different exemplary implementations 340, 350, and 360 of an occupant seat map for a specific vehicle. As shown in FIG. 3: (i) first implementation 340 provides a pictorial illustration along with numerical references from chart 310 of each type of object/occupant (or lack thereof) for each vehicle seat; (ii) second implementation 350 provides a box diagram with numerical references from chart 310 of each type of object/occupant (or lack thereof) for each vehicle seat; and (iii) third implementation 360 provides a simple numerical sequence with numerical references from chart 310 of each type of object/occupant (or lack thereof) for each vehicle seat. In this particular exemplary for this particular vehicle, the different exemplary implementations 340, 350, 360 each depict: (i) a front driver seat 341 being occupied by a large adult; (ii) a front passenger seat 342 being unoccupied; (iii) a rear driver-side seat 343 being occupied by a mid-size child; (iv) a rear middle seat 344 being occupied by an object; and (v) a rear passenger-side seat 345 being occupied by a small-size adult.

FIG. 4 is a flowchart of the above-referenced step (or sub-process) 232 of the process 200 of FIG. 2, including the generation of a vision-based occupant-seat map, and that can be implemented in connection with the vehicle 100 of FIG. 1, in accordance with exemplary embodiments. As depicted in FIG. 4, camera and/or range sensor data 401 (e.g., from step 230 of FIG. 2) is utilized in generating a pose for the occupant (step 402). In various embodiments, the processor 142 generates a two-dimensional pose of the human occupant during step 402.

Also in various embodiments, stored data regarding known human proportions is obtained (step 404). In various embodiments, average dimensions and proportions are obtained from typical (or average) skeletal maps 403 as shown in FIG. 3, including one or more typical (or average) skeletal maps 403(a) for children, typical (or average) skeletal maps 403(b) for women, and typical (or average) skeletal maps 403(c) for men. In various embodiments, the skeletal maps 403 are retrieved form the stored values 154 stored in the memory 144 of FIG. 1. For example, in various embodiments, the skeletal maps 403 may be generated via prior study and/or measurements and/or from publicly available data, or the like.

In various embodiments, heuristic rules are generated (step 406). In various embodiments, the processor 142 of FIG. 1 generates the heuristic rules based on various measurements corresponding to the skeletal maps 403 for determining age and size of the human occupants of the vehicle seats, for example based on known average values from humans of different age groups and sizes (e.g., weight and height) of human skeletal parameters such as the length, width, and/or configuration of the humans' upper torso, head, shoulders, and/or other skeletal components, along with a location of the arms and/or other skeletal components and/or relative proportions of various skeletal components.

Also in various embodiments, skeleton mapping is performed (step 408). In various embodiments, the processor 142 provides skeleton mapping of the pose of step 408 in accordance with the heuristic rules of step 406. In various embodiments, the skeletal mapping includes measurements and/or estimates of the length, width, and/or configuration of the human occupant's upper torso, head, shoulders, and/or other skeletal components, along with a location of the arms and/or other components of the human skeleton and/or relative proportions of various skeletal components, for comparison with the heuristic rules of step 406.

In various embodiments, during step 410, the skeleton mapping of step 408 is utilized to generate a pose occupant seat mapping. In various embodiments, the pose occupant seat mapping is generated by the processor 142 and utilized for a pose component of the mapping of steps 222 and 224 of FIG. 2. The following table shows an example of the mapping between the measurements obtained from the pose estimator and the occupant class.

TABLE 1
Measurements of Pose Estimator to Occupant Class Mapping

| Measurements | | |
|---|---|---|
| from Pose | Dimension | |
| Estimator | (mm) | Occupant Class |
| Sitting height | 935 ± 8 | Large Adult Male |
| | 884 ± 5 | Mid-Sized Adult Male |
| | 787 ± 13 | Small Adult Female |
| | 723.9 ± 12.7 | Large-size Child |
| Shoulder breadth | 475 ± 8 | Large Adult Male |
| | 429 ± 13 | Mid-Sized Adult Male |
| | 358 ± 8 | Small Adult Female |
| | 315 ± 7.6 | Large-size Child |
| Shoulder pivot height | 549 ± 8 | Large Aduit Male |
| | 513 ± 8 | Mid-Sized Adult Male |
| | 445 ± 13 | Small Adult Female |
| | 391.2 ± 7.6 | Large-size Child |
| Chest circumference | 1135 ± 15 | Large Adult Male |
| | 986 ± 15 | Mid-Sized Adult Male |
| | 866 ± 15 | Small Adult Female |
| | 698.5 ± 12.7 | Large-size Child |
| Waist circumference | 1087 ± 15 | Large Adult Male |
| | 851 ± 15 | Mid-Sized Adult Male |
| | 775 ± 15 | Small Adult Female |
| | 711.2 ± 12.7 | Large-size Child |

An extended version of this table is used to find the most likely class that matches with the different measurements.

FIG. 5 is a flowchart of the above-referenced combined step (or sub-process) 235 of the process 200 of FIG. 2, including the generation of a speech-based occupant-seat map, and that can be implemented in connection with the vehicle 100 of FIG. 1, in accordance with exemplary embodiments. As depicted in FIG. 5, audio sensors 128 (e.g., in-cabin microphones) capture audio data from step 234 (described above in connection with FIG. 2), such as speech utterances from the occupants of the vehicle seats. Also as depicted in FIG. 5 and noted above with respect to FIG. 2, source separation (step 236) and feature extraction (step 238) are performed by the processor 142 with respect to the audio/speech signals of the occupants in various embodiments. In certain embodiments, the feature extraction utilizes feature vectors, and that may include, for example, pitch information, Mel-frequency cepstral coefficients (MFCCs), Bark frequency cepstral coefficient (BFCC), Filterbank Energies, Log Filterbank Energies Linear Prediction (PLP) coefficients and/or Spectral Sub-band Centroids of the acoustic signals. For example, MFCC's are frequencial coefficients that represent audio, based on perception as a way to mimic the behavior of the human ears. It is derived from the Fourier Transform (FTT) or the Discrete Cosine Transform (DCT) of the acoustic utterance. One difference between the FFT/DCT and the MFCC is that in the MFCC, the frequency bands are positioned logarithmically (on the mel scale) which approximates the human auditory system's response more closely than the linearly spaced frequency bands of FFT or DCT. In various embodiments, this provides for improved processing of data.

Also in various embodiments, the extracted features are incorporated into a speech-based age group clustering model (step 502). This model can be built using k-means, fuzzy C-means, hierarchical clustering, self-organized map (SOM) neural networks, Gaussian mixture model (GMM), or hidden Markov models (HHMs). For example k-means can be as a hard clustering approach or GMM can be used as a soft clustering technique. In various embodiments, the processor 142 utilizes the extracted features of step 238 in connection with a clustering technique, such as a GMM, in order to categorize age and/or other characteristics of the speech utterances of the occupants based on comparison with known or expected characteristics or patterns of speech utterances for different age groups and/or other classifications (e.g., as stored values 154 of the memory 144 of FIG. 1). GMM models the characteristics of each speaker's spectral features. A Gaussian mixture density is defined as a sum of a number of Gaussian components. Training data representing different quiet and noisy conditions (stationary and non-stationary noises at different level of signal to noise ratio) are used to estimate the GMM model parameters. Iterative expectation maximization (EM) algorithm is used to find the values for the parameters in the model that maximize the likelihood function. EM algorithm clusters the Gaussian mixtures and average of added mixtures is used as a matching score. Speaker age group corresponds to maximum matching score is the output of the algorithm. In various embodiments, during step 504, the modelling of step 502 is utilized by the processor 142 for generating a speech component of the mapping of steps 222 and 224 of FIG. 2.

FIG. 6 is a flowchart of the above-referenced combined step (or sub-process) 220 of the process 200 of FIG. 2, including an occupant interaction in confirming or refining the occupant-seat map, and that can be implemented in connection with the vehicle 100 of FIG. 1, in accordance with exemplary embodiments. As depicted in FIG. 6 and described above in connection with FIG. 2, a preliminary occupant seat map is generated at step 238 and displayed for the user. Also as depicted in FIG. 6 and described above, user inputs are received at step 230 with respect to the preliminary occupant seat map.

Also in various embodiments, as depicted in FIG. 6, a determination is made during step 602 as to whether the user inputs represent a confirmation or refinement of the preliminary occupant seat map. In various embodiments, this determination is made by the processor 142. In various embodiments, if it is determined at step 602 that the user inputs are a confirmation of the preliminary occupant seat map, then the preliminary occupant seat map is maintained by the processor 142 as the occupant seat map at step 604, and is utilized as the final occupant in the above-described step 234 of FIG. 2. Conversely, in various embodiments, if it is determined at step 602 that the user inputs are a refinement (or adjustment) of the preliminary occupant seat map, then the preliminary occupant seat map is refined (i.e., adjusted) in the manner requested in the user inputs for use as the occupant seat map at step 606, and is utilized as the final occupant in the above-described step 234 of FIG. 2

Accordingly, methods, systems, and vehicles are provided for generating an occupant seat mapping of a vehicle and for controlling vehicle systems based on the occupant seat mapping. In various embodiments, sensor data from multiple different types of sensor modalities are utilized in generating an occupant seat map for the vehicle, for example in determining whether each vehicle seat is occupied, and if so whether such vehicle seat is occupied by an object, pet, or human, along with an age and size (e.g., in terms and/or weight) of the human occupant. In various embodiments, the occupant seat map is utilized in adjusting control of various vehicle systems such as, by way of example, air bag deployment, seat belt adjustment, infotainment content customization, and/or other system controls.

It will be appreciated that the systems, vehicles, and methods may vary from those depicted in the Figures and described herein. For example, the vehicle 100 of FIG. 1, and the control system 102 and components thereof, may vary in different embodiments. It will similarly be appreciated that the steps of the process 200 may differ from those depicted in FIG. 2, and/or that various steps of the process 200 may occur concurrently and/or in a different order than that depicted in FIG. 2. It will similarly be appreciated that the various implementations and sub-processors of FIGS. 3-6 may also differ in various embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A system comprising:
one or more first sensors of a first sensor modality configured to obtain first sensor data pertaining to an occupancy status of one or more seats of a vehicle;
one or more second sensors of a second sensor modality, different from the first sensor modality, configured to obtain second sensor data pertaining to the occupancy status of the one or more seats of the vehicle; and
a processor coupled to the one or more first sensors and the one or more second sensors and configured to at least facilitate determining the occupancy status of the one or more seats of the vehicle based on a fusion of the first sensor data and the second sensor data.

2. The system of claim 1, wherein the one or more seats comprises a plurality of seats of the vehicle, and the processor is configured to:
generate an occupant seat map for the vehicle based on the occupancy status of each of the plurality of seats; and
provide instructions for controlling one or more vehicle systems based on the occupant seat map.

3. The system of claim 2, wherein the processor is configured to generate the occupant seat map based on different preliminary maps for the first sensor modality and the second sensor modality with different weights assigned to each of the different preliminary maps.

4. The system of claim 3, wherein the processor is configured to:
provide instructions for a display system to display the occupant seat map for a user of the vehicle; and
refine the occupant seat map based on inputs provided by the user of the vehicle.

5. The system of claim 1, wherein the first and second modalities comprise two or more of the following: a weight sensing modality, a vision sensing modality, a range sensing modality, an audio sensing modality, and a biometric sensing modality.

6. The system of claim 1, wherein:
the first sensor modality comprises a weight sensing modality; and
the second sensor modality comprises a vision sensing modality.

7. The system of claim 1, further comprising:
one or more third sensors of a third sensor modality, different from both the first sensor modality and the second sensor modality, and configured to obtain third sensor data pertaining to the occupancy status of the one or more seats of the vehicle;
wherein the processor is configured to at least facilitate determining the occupancy status of the one or more seats of the vehicle based on fusion of the first sensor data, the second sensor data, and the third sensor data.

8. The system of claim 7, wherein the first, second, and third modalities comprise three or more of the following: a weight sensing modality, a vision sensing modality, a range sensing modality, an audio sensing modality, and a biometric sensing modality.

9. The system of claim 7, wherein:
the first sensor modality comprises a weight sensing modality;
the second sensor modality comprises a vision sensing modality; and
the third sensor modality comprises an audio sensing modality.

10. A method comprising:
obtaining, via one or more first sensors of a first sensor modality, first sensor data pertaining to an occupancy status of one or more seats of a vehicle;
obtaining, via one or more second sensors of a second sensor modality, different from the first sensor modality, second sensor data pertaining to the occupancy status of the one or more seats of the vehicle; and
determining, via a processor, the occupancy status of the one or more seats of the vehicle based on a fusion of the first sensor data and the second sensor data.

11. The method of claim 10, wherein the one or more seats comprises a plurality of seats of the vehicle, and the method further comprises:
generating, via the processor, an occupant seat map for the vehicle based on the occupancy status of each of the plurality of seats; and
providing, via the processor, instructions for controlling one or more vehicle systems based on the occupant seat map.

12. The method of claim 11, wherein the step of generated the occupant seat map comprises generating the occupant seat map based on different preliminary maps for the first sensor modality and one or more second sensor modalities with different weights assigned to each of the different preliminary maps.

13. The method of claim 12, further comprising:
displaying the occupant seat map for a user of the vehicle, via a display system in accordance with instructions provided by the processor; and
refining, via the processor, the occupant seat map based on inputs provided by the user of the vehicle.

14. The method of claim 10, wherein the first and second modalities comprise two or more of the following: a weight sensing modality, a vision sensing modality, a range sensing modality, an audio sensing modality, and a biometric sensing modality.

15. The method of claim 10, wherein:
the first sensor modality comprises a weight sensing modality; and
the second sensor modality comprises a vision sensing modality.

16. The method of claim 10, further comprising:
obtaining, via one or more third sensors of a third sensor modality, different from both the first sensor modality and the second sensor modality, third sensor data pertaining to the occupancy status of the one or more seats of the vehicle;
wherein the step of determining the occupancy status comprises determining, via the processor, the occupancy status of the one or more seats of the vehicle based on fusion of the first sensor data, the second sensor data, and the third sensor data.

17. The method of claim 16, wherein the first, second, and third modalities comprise three or more of the following: a weight sensing modality, a vision sensing modality, a range sensing modality, an audio sensing modality, and a biometric sensing modality.

18. The method of claim 16, wherein:
the first sensor modality comprises a weight sensing modality;
the second sensor modality comprises a vision sensing modality; and
the third sensor modality comprises an audio sensing modality.

19. A vehicle comprising:
a body;
a propulsion system configured to generate movement of the body;
one or more first sensors of a first sensor modality configured to obtain first sensor data pertaining to an occupancy status of one or more seats of a vehicle;
one or more second sensors of a second sensor modality, different from the first sensor modality, configured to obtain second sensor data pertaining to the occupancy status of the one or more seats of the vehicle; and
a processor coupled to the one or more first sensors and the one or more second sensors and configured to at least facilitate determining the occupancy status of the one or more seats of the vehicle based on a fusion of the first sensor data and the second sensor data.

20. The vehicle of claim 19, wherein the one or more seats comprises a plurality of seats of the vehicle, and the processor is configured to:
generate an occupant seat map for the vehicle based on the occupancy status of each of the plurality of seats; and
provide instructions for controlling one or more vehicle systems based on the occupant seat map.
